(19) United States
(12) Patent Application Publication
(10) Pub. No.: US 2012/0255400 A1
(43) Pub. Date: Oct. 11, 2012

(54) Wing Ding

(76) Inventor: Jim Flud, Glen Rose, TX (US)

(21) Appl. No.: 13/083,564

(22) Filed: Apr. 10, 2011

(51) Int. Cl. B25B 13/50

(52) U.S. Cl. 81/176.1

(57) ABSTRACT

A tool to mechanically rotate a wing nut may include an H shaped body having a first side member, a second side member being in a spaced relationship to the first side member and a bridge member to connect the first side member with the second side member and a cylinder housing to connect to the H shaped body to provide a socket to connect to a power tool to mechanically rotate the wing nut. The power tool may be a power drill, and the first side member may be a rectangle. The second side member may be a rectangle, and the bridge member may be a rectangle. The bridge member may include a center aperture, and the first side member may include a first slot to define and engaging projection.

### FIELD OF THE INVENTION

The present invention relates to drive tools and more particularly to a drive tool to remove a wing nut which may be used to secure a hatch on a frac tank for tankers.

### BACKGROUND

U.S. Pat. No. 7,293,482 discloses a tool for installing and removing wing nuts. The tool includes an ergonomic, rigid handle for gripping by the hand of the user. One end of the handle includes wing nut engagement features that center the wing nut for a snug engagement by the tool. The tool is manually rotated to either tighten or loosen wing nuts. The tool is particularly useful for the installation and removal of wing nuts used to secure storm panels over the windows and doors of a building structure.

U.S. Pat. No. 6,314,841 discloses a hand tool including an elongated substantially rigid body having generally opposite first and second ends. The first end has a first socket of a given width and depth formed longitudinally therein. A first slot extends longitudinally into the first end and across the first socket. The first slot has a width less than the width of the first socket. The second end has a second socket formed therein which also extends longitudinally. The first and second sockets can be of different widths and depths. This hand tool is useful on projects where a variety of fastener sizes and types are encountered.

U.S. Pat. No. 5,697,268 discloses a socket for driving a wing nut or the like including a cylindrical housing having a bore at one end for receiving the wing nut therein. A port at the opposed end of the housing receives the end of a shank of a driving tool such as a ratchet or the like. First and second pairs of radially offset slots are positioned within the housing and about the bore, the slots having relatively different widths and/or lengths. Upon insertion of a wing nut within the bore, the wings thereof extend through the opposed slots of a pair of slots. The relatively-sized widths and/or lengths of the first and second pairs of slots enable a wide range of wing nuts to be driven by one socket.

U.S. Pat. No. 4,823,650 discloses a power driven wrench that is used to fasten and secure helical spring wire connectors commonly known as a wing nuts or wire nuts. The invention consists of a cone shaped plastic housing and a hexagonal shaft that extends outwardly from the bottom of the housing. The shaft is placed within a chuck of standard power tools such as power screwdrivers or variable speed drills. The housing is open at the top and hollow inside to receive the connectors. Two slots are placed within the walls of the housing to receive and hold the wings or flanges of the connectors. A number of ribs, concentrically placed around the inner wall of the housing, are also provided to engage ribs placed on certain types of connectors that have no flanges. The ribs prevent free rotation of the connector within the housing. A magnet is also embedded within the bottom of the housing. The magnet holds the connector within the housing by attracting the helical spring found in typical connectors. The housing is made of high strength, non-conductive plastic.

### SUMMARY

A tool to mechanically rotate a wing nut may include an H shaped body having a first side member, a second side member being in a spaced relationship to the first side member and a bridge member to connect the first side member with the second side member and a cylinder housing to connect to the H shaped body to provide a socket to connect to a power tool to mechanically rotate the wing nut.

The power tool may be a power drill, and the first side member may be a rectangle.

The second side member may be a rectangle, and the bridge member may be a rectangle.

The bridge member may include a center aperture, and the first side member may include a first slot to define and engaging projection.

The second side member may include a second slot to define another engaging projection.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a front view of the tool of the present invention;

FIG. 2 illustrates a side view of the tool of the present invention;

FIG. 3 illustrates a bottom view of the tool of the present invention;

FIG. 4 illustrates a back view of the tool of the present invention;

FIG. 5 illustrates a top view of the tool of the present invention; and

FIG. 6 illustrates the tool of the present invention in operation.

### DETAILED DESCRIPTION

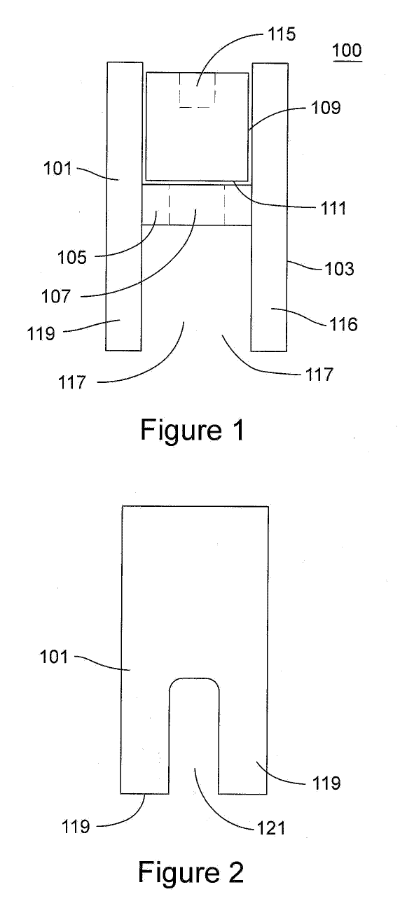

FIG. 1 illustrates the wing ding tool 100 which may be an H shaped body which may be formed from rigid durable material or combination of materials selected from plastic, metal, metal alloy or other appropriate material and may be adapted to be mounted and to be mechanically rotated by a drill which may be electric or air driven. FIG. 1 illustrates that the tool 100 may include a first side member 101 and a second side member 103, and the first side member 101 may be a substantial rectangle. The second side member 103 which may be a substantial rectangle and which may be positioned opposed to the first side member 101 and may be a substantial mirror of the first side member 101. The first side member 101 and the second side member 103 may be positioned in a spaced relationship and may be connected by a bridge member 105 which may be a substantial rectangle and may include a substantial central aperture 107 which may extend through the bridge member 105.

A cylinder housing 109 may be positioned and connected to an interior surface of the first side member 101 and the second side member 103 and may be positioned and connected on an upper surface of the bridge member 105. The cylinder housing 109 may be hollow and may include an open end 111 to cooperate with the center aperture 107 of the bridge member 105, and the opposing end 113 of the cylinder housing 109 may include an aperture 115 which may extend through the cylinder housing 109 in order to cooperate with a drill to mechanically rotate the tool 100. The aperture 115 may form a hollow socket to mate with the drill bit.

The first side member 101, the second side member 103 and the bridge member 105 may be positioned in a spaced relationship in order to define a first slot 117 to in part define engaging projections 119 to cooperate and to rotate a wing nut 121 which may be used to secure a hatch on a frac tank for tankers.

FIG. 2 illustrates a side view of the first side member 101 and illustrates a second slot 121 to further define the engaging projections 119 and may extend from the bottom of the first side member 110 and may extend to the bridge member 105.

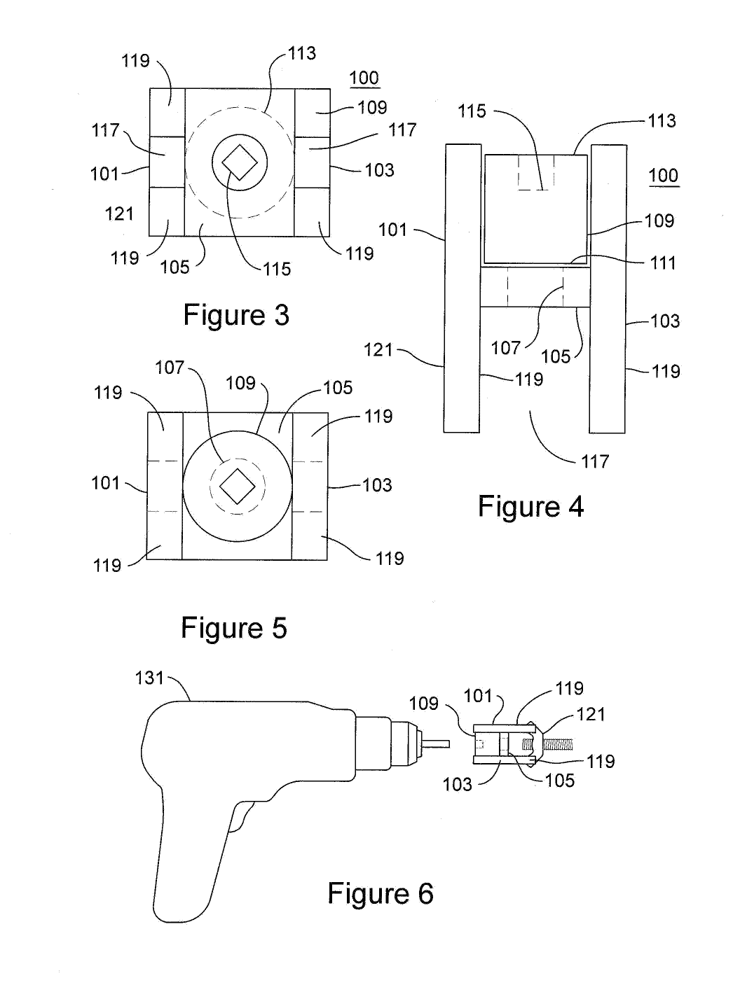

FIG. 3 illustrates the wing ding tool 100 which may be an H shaped body which may be formed from rigid durable material or combination of materials selected from plastic, metal, metal alloy or other appropriate material and may be adapted to be mounted and to be mechanically rotated by a drill which may be electric or air driven. FIG. 3 illustrates that the tool 100 may include a first side member 101 and a second side member 103, and the first side member 101 may be a substantial rectangle. The second side member 103 which may be a substantial rectangle and which may be positioned opposed to the first side member 101 and may be a substantial mirror of the first side member 101. The first side member 101 and the second side member 103 may be positioned in a spaced relationship and may be connected by a bridge member 105 which may be a substantial rectangle and may include a substantial central aperture 107 which may extend through the bridge member 105.

A cylinder housing 109 may be positioned and connected to an interior surface of the first side member 101 and the second side member 103 and may be positioned and connected on an upper surface of the bridge member 105. The cylinder housing 109 may be hollow and may include an open end 111 to cooperate with the center aperture 107 of the bridge member 105, and the opposing end 113 of the cylinder housing 109 may include an aperture 115 which may extend through the cylinder housing 109 in order to cooperate with a drill to mechanically rotate the tool 100. The aperture 115 may form a hollow socket to mate with the drill bit.

The first side member 101, the second side member 103 and the bridge member 105 may be positioned in a spaced relationship in order to define a first slot 117 to in part define engaging projections 119 to cooperate and to rotate a wing nut 121 which may be used to secure a hatch on a frac tank for tankers.

FIG. 3 illustrates the first side member 101 and illustrates a second slot 121 to further define the engaging projections 119 and may extend from the bottom of the first side member 110 and may extend to the bridge member 105.

FIG. 4 illustrates the wing ding tool 100 which may be an H shaped body which may be formed from rigid durable material or combination of materials selected from plastic, metal, metal alloy or other appropriate material and may be adapted to be mounted and to be mechanically rotated by a drill which may be electric or air driven. FIG. 3 illustrates that the tool 100 may include a first side member 101 and a second side member 103, and the first side member 101 may be a substantial rectangle. The second side member 103 which may be a substantial rectangle and which may be positioned opposed to the first side member 101 and may be a substantial mirror of the first side member 101. The first side member 101 and the second side member 103 may be positioned in a spaced relationship and may be connected by a bridge member 105 which may be a substantial rectangle and may include a substantial central aperture 107 which may extend through the bridge member 105.

A cylinder housing 109 may be positioned and connected to an interior surface of the first side member 101 and the second side member 103 and may be positioned and connected on an upper surface of the bridge member 105. The cylinder housing 109 may be hollow and may include an open end 111 to cooperate with the center aperture 107 of the bridge member 105, and the opposing end 113 of the cylinder housing 109 may include an aperture 115 which may extend through the cylinder housing 109 in order to cooperate with a drill to mechanically rotate the tool 100. The aperture 115 may form a hollow socket to mate with the drill bit.

The first side member 101, the second side member 103 and the bridge member 105 may be positioned in a spaced relationship in order to define a first slot 117 to in part define engaging projections 119 to cooperate and to rotate a wing nut 121 which may be used to secure a hatch on a frac tank for tankers.

FIG. 4 illustrates the first side member 101 and illustrates a second slot 121 to further define the engaging projections 119 and may extend from the bottom of the first side member 110 and may extend to the bridge member 105.

FIG. 5 illustrates the wing ding tool 100 which may include a first side member 101, a second side member 103, and a bridge member 105 may include a substantial central aperture 107 which may extend through the bridge member 105.

A cylinder housing 109 may be positioned and connected to an interior surface of the first side member 101 and the second side member 103 and may be positioned and connected on an upper surface of the bridge member 105.

FIG. 6 illustrates the wing ding tool 100 which may include a first side member 101, a second side member 103, and a bridge member 105 may include a substantial central aperture 107 which may extend through the bridge member 105.

A cylinder housing 109 may be positioned and connected to an interior surface of the first side member 101 and the second side member 103 and may be positioned and connected on an upper surface of the bridge member 105.

FIG. 6 additionally illustrates a power tool 131 such as a power drill to engage the cylinder housing 109 and engage the engaging projections 119 to mechanically rotate the wing nut 121.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A tool to mechanically rotate a wing nut, comprising:
an H shaped body having a first side member, a second side member being in a spaced relationship to the first side member and a bridge member to connect the first side member with the second side member;
a cylinder housing to connect to the H shaped body to provide a socket to connect to a power tool to mechanically rotate the wing nut.

2) A tool to mechanically rotate a wing nut as in claim 1, wherein the power tool is a power drill.

3) A tool to mechanically rotate a wing nut as in claim 1, wherein the first side member is a rectangle.

4) A tool to mechanically rotate a wing nut as in claim 1, wherein the second side member is a rectangle.

5) A tool to mechanically rotate a wing nut as in claim 1, wherein the bridge member is a rectangle.

6) A tool to mechanically rotate a wing nut as in claim 1, wherein the bridge member includes a center aperture.

7) A tool to mechanically rotate a wing nut as in claim 1, wherein the first side member includes a first slot to define and engaging projection.

8) A tool to mechanically rotate a wing nut as in claim 7, wherein the second side member includes a second slot to define another engaging projection.
